(19) United States
(12) Patent Application Publication
(10) Pub. No.: US 2015/0224965 A1
(43) Pub. Date: Aug. 13, 2015

(54) WINDSHIELD WIPER SQUEEGEE ATTACHMENT

(71) Applicant: Cara Petrowski, Wausau, WI (US)

(72) Inventor: Cara Petrowski, Wausau, WI (US)

(21) Appl. No.: 14/178,547

(22) Filed: Feb. 12, 2014

(51) Int. Cl. B60S 1/38

(52) U.S. Cl. CPC B60S 1/38; B60S 2001/3827; B60S 2001/3837

(57) ABSTRACT

A windshield wiper attachment for windshield scrubbing, where the wiper attachment includes: a wiper arm; a motor positioned above the wiper arm; a squeegee extending the length of the wiper arm; and a bug scrubber within an opening within the squeegee, wherein said bug scrubber includes a retracted position and an extended position. The bug scrubber is capable of scrubbing contact with a windshield in the extended position. The motor provides a mechanism to move the bug scrubber between the retracted position and extended position.

### BACKGROUND OF THE INVENTION

1. Field of Invention

The present invention relates to an attachment that inserts onto a conventional windshield wiper to provide extra cleaning power for the windshield.

2. Description of Related Art

It is well known windshield wipers are used on numerous vehicles in order to wipe or remove water, rain, snow and condensation off the surface of the windshield. The use of the windshield wiper provides a clear view for the driver and passenger of a vehicle. Wipers primarily keep the windshields free from obstruction during a rain or snow storm. Further, wipers are used to actually clean the windshields when dirt or debris accumulates over the windshields. Normally fluid is provided in the vehicle that may be sprayed onto the windshield while the windshield wipers move over the windshield. This technique helps to clean off any dirt or debris that has built up over the windshield.

One common problem associated with windshields is the buildup of insects or bugs that may smear the windshield if struck while the vehicle is operating. Many times bug fluids are smeared on the windshield in certain driving conditions and therefore are difficult to remove from the windshield without additional labor and tools. It would therefore be advantageous to have a device that could attach to the windshield wiper arm to improve the removal of bug smears on the windshield. Further, it would be advantageous to have device that is easily attached to an existing windshield wiper arm and therefore easily integrated into the wiper system.

### SUMMARY OF THE INVENTION

The present invention relates to a windshield wiper attachment for windshield scrubbing comprising; a wiper arm; a motor positioned above the wiper arm; a squeegee extending the length of the wiper arm; and a bug scrubber within an opening within the squeegee, wherein said bug scrubber includes a retracted position and an extended position. The bug scrubber is capable of scrubbing contact with a windshield in the extended position. The motor provides a means to move the bug scrubber between the retracted position and extended position.

### BRIEF DESCRIPTION OF DRAWINGS

FIG. 1 provides a side perspective view of a windshield wiper squeegee in accordance with the present invention.

FIG. 2 depicts a side view showing the squeegee protruding from the housing of the wiper attachment.

### DETAILED DESCRIPTION

The present invention relates to a windshield wiper attachment that includes a sponge squeegee where the squeegee's head includes a bug scrubbing surface that extends and retracts for application over a windshield.

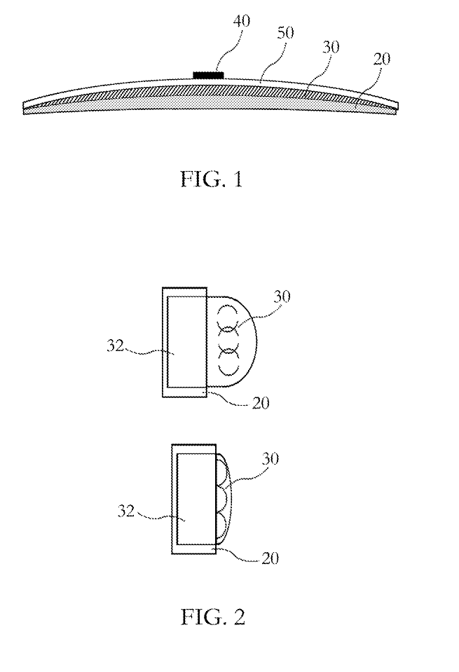

In reference to FIG. 1, a prospective view of a windshield squeegee attachment in accordance with the present invention is depicted. The windshield squeegee attachment includes a motor 40 centered at the top of a wiper arm 50. The motor 40 provides a mechanism to activate the retraction and extension of the bug scrubber 30. The bug scrubber 30 extends over the length of the wiper attachment and is just below the wiper arm 50. The bug scrubber 30 provides a squeegee that extends outwardly for application over a windshield. Below the bug scrubber 30 is a rubber squeegee 20. This rubber squeegee 20 wipes the surface of the windshield similar to the windshield wiper.

The windshield wiper attachment attaches to a conventional windshield wiper arm where the motor 40 activates the extension of the bug scrubber 30. FIG. 2 depicts a side sectional view of the windshield wiper attachment shown in FIG. 1. As shown the bug scrubber 30 may remain retracted in a housing 20. An opening 32 is provided for the insertion of the bug scrubber sponge 30. This opening 32 keeps the bug scrubber 30 in place during operation. The motor 40 may be activated to extend the bug scrubber 30 into an extended position as shown in FIG. 2A. FIG. 2B shows the bug scrubber 30 in a retracted position.

The windshield wiper attachment is attached to the windshield arm and therefore enables use as a conventional windshield wiper and allows for a bug scrubber to be applied to the windshield when desired. When the scrubber is extended it applies over the surface of the windshield helping to remove bug debris and film from the windshield. Use of the bug scrubber in conjunction with wiper fluid or conventional precipitation allows for the removal of the bugs and bug fluid that may have adhered to the windshield. Further, the bug scrubber is placed in this recessed track or opening that allows for easy replacement of the bug scrubber once it is used or ineffective in removing bugs from the windshield surface.

What is claimed is:

1. A windshield wiper attachment for windshield scrubbing comprising:
a. a wiper arm;
b. a motor positioned above the wiper arm;
c. a squeegee extending the length of the wiper arm; and
d. a bug scrubber within an opening within the squeegee, wherein said bug scrubber includes a retracted position and an extended position.

2. The windshield wiper attachment according to claim 1, where the bug scrubber is capable of scrubbing contact with a windshield in the extended position.

3. The windshield wiper attachment according to claim 1, where said motor provides a means to move the bug scrubber between the retracted position and extended position.
